(19) United States
(12) Patent Application Publication
(10) Pub. No.: US 2005/0112471 A1
(43) Pub. Date: May 26, 2005

(54) Nickel zinc electrochemical cell incorporating dendrite blocking ionically conductive separator

(76) Inventors: Muguo Chen, South Salem, NY (US); Fuyuan Ma, Yorktown, NY (US); Jennifer Leveille, Brewster, NY (US); Tsepin Tsai, Chappaqua, NY (US); Anu Eapen, New City, NY (US); Ben Lewis, Yonkers, NY (US); Liang Liang, Yorktown Heights, NY (US); Xuejun Cao, Nanuet, NY (US); Alex Elien, Bronx, NY (US); Octavia Elien, Bronx, NY (US)

Correspondence Address: Reveo, Inc., 85 Executive Blvd., Elmsford, NY, 10523, US

(21) Appl. No.: 10/445,271

(22) Filed: May 23, 2003

Related U.S. Application Data
(63) Continuation-in-part of application No. 09/943,053, filed on Aug. 30, 2001.
(63) Continuation-in-part of application No. 09/942,887, filed on Aug. 30, 2001, now Pat. No. 6,849,702.
(63) Continuation-in-part of application No. 09/259,068, filed on Feb. 26, 1999, now Pat. No. 6,605,391.
(63) Continuation-in-part of application No. 10/013,016, filed on Nov. 30, 2001.
Application No. 10/013,016 is a continuation of application No. 09/482,126, filed on Jan. 11, 2000, now Pat. No. 6,358,651.
(60) Provisional application No. 60/382,926, filed on May 23, 2002.

(51) Int. Cl. H01M 2/16

(52) U.S. Cl. 429/253; 429/347

(57) ABSTRACT

A nickel-zinc electrochemical cell is disclosed using a polymer matrix separator. The polymer matrix separator includes a polymerization product of one or more monomers selected from the group of water-soluble, ethylenically-unsaturated acids and acid derivatives, and a crosslinking agent, and serves as a primary or supplemental source of electrolyte ionic species for the electrochemistry. Ionic species is contained as a solution phase within the polymer matrix membrane, allowing it to behave as a liquid electrolyte without the disadvantages. In secondary batteries (i.e., rechargeable), polymer matrix membranes are particularly useful as both an electrolyte reservoir and as a dendrite resistant separator between the charging electrode and the zinc electrode. The polymer matrix membrane protects the electrodes from corrosion and prevents zinc oxidation product from the zinc electrode to contaminate the electrolyte.

### RELATED CASES

This application claims priority to U.S. Provisional Application Ser. No. 60/382,926 filed May 23, 2003 entitled “Nickel Zinc Electrochemical Cell: by Muguo Chen, and is a Continuation-in-Part application of co-pending U.S. Ser. No. 09/943,053 entitled “Polymer Matrix Material”, by Robert Callahan, Mark Stevens and Muguo Chen, filed on Aug. 30, 2001; U.S. Ser. No. 09/942,887 entitled “Electrochemical Cell Incorporating Polymer Matrix Material”, by Robert Callahan, Mark Stevens and Muguo Chen, filed on Aug. 30, 2001; U.S. Ser. No. 09/259,068, filed Feb. 26, 1999 entitled SOLID GEL MEMBRANE, and U.S. Ser. No. 10/013,016, filed Nov. 30, 2001 (which is a continuation of Ser. No. 09/482,126, filed Jan. 11, 2000, now U.S. Pat. No. 6,358,651) entitled SOLID GEL MEMBRANE SEPARATOR IN RECHARGEABLE ELECTROCHEMICAL CELLS; all of which are incorporated by reference herein in their entireties.

### FIELD OF THE INVENTION

This invention relates generally to a nickel zinc electrochemical cells, and more particularly to nickel-zinc electrochemical cells incorporating dendrite blocking ionically conductive separators, which has the potential to provide high power output, and operate over a wider temperature range and a larger number of recharging cycles as compared to conventional nickel-zinc batteries.

### BACKGROUND OF THE INVENTION

Batteries and fuel cells operate on electrochemical redox reactions that convert chemical energy within the active materials directly to electric energy. In particular, nickel-zinc batteries are attractive in that they are electrically rechargeable and have desirable battery characteristics such as environmental friendly, high energy density, high power density, high working voltage, low material cost, and low temperature duty characteristics. Discharge and recharging electrochemistry of nickel-zinc electrochemical cells is shown schematically in FIG. 1.

As shown, nickel-zinc cells typically have a zinc based negative electrode and a nickel based positive electrode. The positive and negative electrodes are physically separated and electrically insulated by a separator. While serving as a barrier to the transport of active materials of the different electrodes, a separator should provide ionic conduction. Good ionic conductivity is necessary to ensure that an electrochemical cell/battery is capable of delivering usable amounts of power for a given application.

In a rechargeable electrochemical cell, a separator is also used to prevent short-circuiting, caused by metal dendrite penetration during recharging. Zinc species from the negative zinc electrode is dissolved as zincate ion into the electrolyte solution during discharge. At the time of charge, zinc is deposited back onto the negative electrode. The current distribution is not very uniform on the negative electrode however, causing zinc to be unevenly deposited, resulting in shape change of the zinc electrode. This causes shape change of the electrode. Under diffusion-limiting depositing conditions, the deposited metallic zinc tends to grow in the form of tree branches (dendrites) which could penetrate the separator until it reaches the positive electrode, causing a short circuit.

One approach to decreasing the negative effects of dendrites and shape change of the zinc electrode during recharging is to use lower concentration (e.g., on the order of 20% or lower) electrolyte solution. However, power output will be sacrificed. Further, low temperature operation is difficult, as is know in the art.

Prior attempts to solve this problem have been based generally on use of several layers of separator materials between the nickel and zinc electrodes. For example, U.S. Pat. No. 5,824,434 discloses use of a multi-layered metal oxide film between the positive and negative electrodes having small apertures to allow ion passage and to inhibit growth of dendrites grown from the electrodes.

Another general approach to prevent dendrite formation is to provide turbulent electrolyte flow at the zinc electrode during recharging. For example, a “Vibrocell” battery, described in U.S. Pat. No. 3,923,550, discloses a system wherein zinc electrodes are driven in a fast reciprocating vertical movement by mechanical means, allowing turbulent electrolyte flow in the vicinity of the zinc surface. Also, U.S. Pat. No 4,684,585 discloses a rotating stack of bipolar electrodes having electrolyte introduced therein during rotation, allowing turbulent electrolyte flow in the vicinity of the zinc surface.

Attempts to improve the separator are also known. For example, U.S. Pat. No. 4,522,902 discloses cross-linked or vulcanized amphophilic or quaternized film forming block copolymers of haloalkyl epoxides and hydroxyl terminated alkadiene polymers as battery separators in nickel-zinc batteries. The quaternized block copolymers are prepared by polymerizing a haloalkyl epoxide in the prescence of a hydroxyl terminated 1,3-alkadiene to form a block copolymer that is then reacted with an amine to form the quaternized or amphophilic block copolymer that is then cured or cross-linked with sulfur, polyamines, metal oxides, and organic peroxides. U.S. Pat. No. 4,544,616 discloses is a microporous substrate carrying therewith an organic solvent of benzene, toluene or xylene with a tertiary organic amine therein, wherein the tertiary amine has three carbon chains each containing from six to eight carbon atoms. U.S. Pat. No. 4,434,215 discloses a battery separator including a mixture of different copolymers of ethylene and acrylic acid or methacrylic acid, the acids being neutralized with an alkali or alkaline earth metal cation, whereupon the separator is dried and intended for use in systems containing alkali solutions. U.S. Pat. No. 4,310,608 discloses a separator in the form of a bag containing a liquid polymer solution (separate from the battery electrolyte). U.S. Pat. No. 4,287,275 discloses a graft polymer formed by initiating and effecting the graft copolymerization of an organic polymeric substrate and an ethylenically unsaturated organic monomer while the polymeric substrate and monomer are in solution.

However, while many of these conventional separators may serve to block dendrites to a degree, lifetime and performance limitations are inevitable. Most of the separators described above (except U.S. Pat. No. 4,310,608) and others that are known in the battery art are dry, and rely on a separate liquid solution for the active ionic conducting electrolyte. This detracts from the desired high ionic conductivity of the membrane, limiting discharge and recharge characteristics.

The foregoing problems thus present major obstacles to the successful development and commercialization of rechargeable nickel-zinc electrochemical cells, for example for use in uninterruptible power supplies, for powering electric vehicles, and for portable devices such as notebook computers, camcorders, and portable telephones. These uses require deep (over 60%) discharge-recharge cycling capacity in the order of three hundred cycles or more, a deficiency of conventional nickel-zinc secondary batteries. It is clear that there is a great need for a separator that can provide improved sufficient ionic conductivity while providing an effective barrier against the penetration of metal dendrites and the diffusion of reaction products.

### SUMMARY OF THE INVENTION

A nickel-zinc electrochemical cell is disclosed using a cross-linked polymer matrix separator. The polymer matrix separator includes a polymerization product of one or more monomers selected from the group of water-soluble, ethylenically-unsaturated acids and acid derivatives, and a crosslinking agent, and liquid electrolyte serves as a primary or supplemental source of ionic species for the electrochemistry. The ionic species is contained as a solution phase within the cross-linked polymer matrix membrane, allowing it to behave as a liquid electrolyte without the disadvantages. In secondary batteries (i.e., rechargeable), polymer matrix membranes are particularly useful as both an electrolyte reservoir and as a dendrite resistant separator between the positive and negative electrode.

The polymer matrix material comprises a polymerization product of a first type of one or more monomers selected from the group of water-soluble, ethylenically-unsaturated acids and acid derivatives. The polymer matrix material also includes a second type monomer, generally as a crosslinking agent. Further, the polymer matrix material may include a water-soluble or water-swellable polymer, which acts as a reinforcing element. In addition, a polymerization initiator may optionally be included. The ionic species may be incorporated during polymerization, or alternatively added to the polymer matrix material after polymerization, and remains embedded in the polymer matrix.

During polymerization, the solution of monomer(s) and the optional water-soluble or water-swellable polymer may include water, a solution of the species ultimately desired within the polymer matrix material, or a combination thereof as solvent. The resultant polymer matrix material, therefore, may contain a useful solution therein, such that the polymer matrix material is ready for use in a particular application. The solvent serves to accommodate the matrix structure, thus acting as a space holder to define the volume of the cured polymer. The amount of solvent used in the reaction process and the degree of cross-linking of the polymer are decided to such that the formed membrane has a minimal or desired volume change when soaked in the electrolyte of the electrochemical device. The solvent can later be replaced with a solution of the proper concentration of the desired ionic species (the “solution-replacement treatment”) This is important because the capability of blocking dendrite penetration and the ionic conductivity are critically linked to the volume, cross-linking degree, and tortuosity of the membrane. Excess swelling of a polymer can reduce the dendrite-blocking capability of the final material. If, however, the material does not provide sufficient electrolyte volume, conductivity is reduced. The solution-replacement treatment may be in the form of dipping, soaking, spraying, contacting (in the presence of a liquid) with ion-exchange resins, or other techniques known to those skilled in the art.

The hydroxide ionic species for the nickel-zinc cell may come from an aqueous alkaline solution of potassium hydroxide, sodium hydroxide, lithium hydroxide, or combinations thereof. Preferably, in a potassium hydroxide solution, for example, the base has a concentration ranging from about 0.1 wt. % to about 55 wt. %, and most preferably about 30 wt. % to about 45 wt. %.

### BRIEF DESCRIPTION OF THE DRAWINGS

Numerous other advantages and features of the present invention will become readily apparent from the following detailed description of preferred embodiments when read in conjunction with the accompanying drawings, wherein:

FIG. 1 is a schematic depiction of a typical nickel-zinc battery;

FIG. 2 is a schematic depiction of an nickel-zinc battery incorporating a hydroxide conductive polymer matrix membrane of the present invention; and

FIG. 3 is a schematic depiction of another embodiment of a nickel-zinc battery incorporating both zinc electrode and a nickel electrode protective polymer matrix membrane of the present invention.

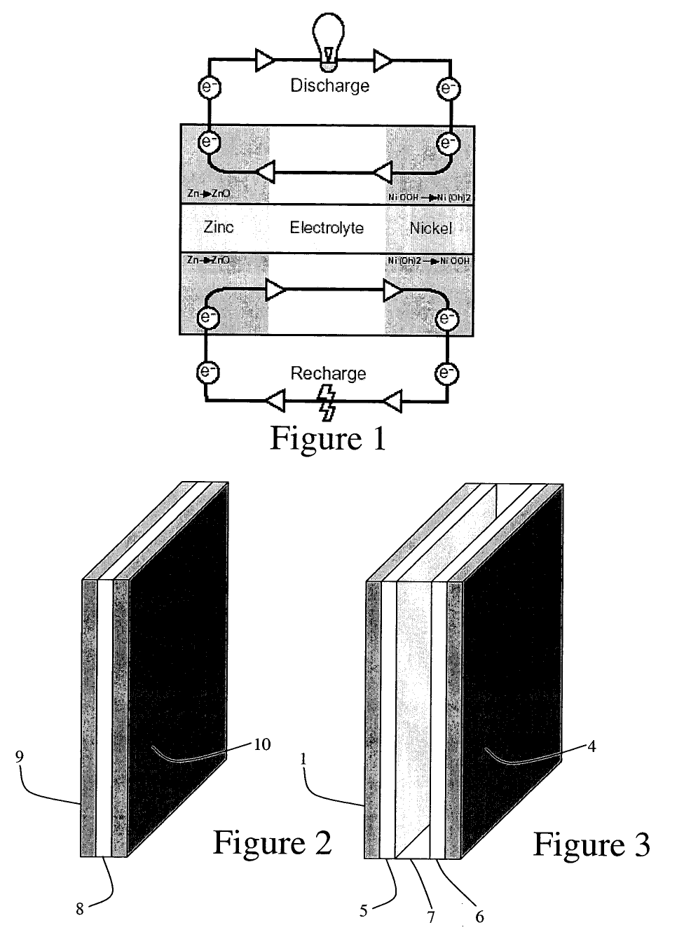

### DETAILED DESCRIPTION OF THE ILLUSTRATIVE EMBODIMENTS

Referring now to the drawings, FIG. 2 depicts a typical nickel-zinc battery, comprising a polymer matrix hydroxide conductive membrane 8 between a zinc electrode 9 and a nickel electrodes. Note that the membrane 8 may actually comprise plural membranes. The membrane(s) contains ionic species, and is also highly conductive to that species. Further, the membrane also provides a protective layer to the electrodes to prevent the usual sources of cell destruction, especially dendrite penetration. The membranes prevent diffusion of zinc oxidation product into the electrolyte solution phase, they prevent corrosion of the zinc electrode by either the electrolyte solution. The nickel-zinc battery of FIG. 3 includes a protective and ionically conductive polymer matrix membrane 5, 6 on the surface of a zinc electrode 3 and a nickel electrode 4, and an aqueous electrolyte 7 between the two.

The polymer matrix membrane may be grafted directly onto the negative electrode, positive electrode, or both. In this case, support for the polymer matrix membrane is provided by the electrode on which the polymer matrix membrane is formed.

When in operation, conducting wires (not shown), usually copper strips, are adhered to exposed portions of the positive and negative electrode. These conducting wires are used to apply an external voltage to the cell to recharge the zinc electrode and send electric energy to external devices. An insulating coating is typically used to cover the exposed joints.

The polymer matrix material comprises a polymerization product of a first type of one or more monomers selected from the group of water-soluble, ethylenically-unsaturated acids and acid derivatives. The polymer matrix material also includes a second type monomer, generally as a crosslinking agent. Further, the polymer matrix material may include a water-soluble or water-swellable polymer, which acts as a reinforcing element. In addition, a polymerization initiator may optionally be included. The water soluble ethylenically unsaturated acids and acid derivatives may generally have the following formula:

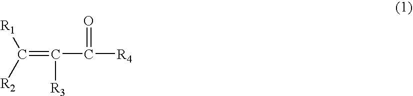

R1, R2, and R3 may be independently selected from, but are not limited to, the group consisting of H, C, C2-C6 alkanes, C2-C6 alkenes, C2-C6 alkynes, aromatics, halogens, carboxylic acid derivatives, sulfates and nitrates;

R4 may be selected from, but is not limited to, the group consisting of NR5, NHR5, NH2, OH, H, halides including but not limited to Cl and Br, OR5, and carboxylic acid derivatives, wherein R5 may be selected from the group consisting of H, C, C2-C6 alkanes, C2-C6 alkenes, C2-C6 alkynes, and aromatics.

Such ethylenically unsaturated acids and derivatives having the general formula (1), include, but are not limited to, methacrylic acid, acrylic acid, acrylamide, fumaramide, fumaric acid, N-isopropylacrylamide, N, N-dimethylacrylamide, 3,3-dimethylacrylic acid, maleic anhydride, and combinations comprising at least one of the foregoing ethylenically unsaturated acids and derivatives.

Other ethylenically unsaturated acids and derivatives monomers having readily polymerizable groups may be used as the first type of monomer, depending on the desired properties. Such monomers include, but are not limited to, 1-vinyl-2-pyrrolidinone, the vinylsulfonic acid and its salts, and combinations comprising at least one of the foregoing ethylenically unsaturated acids and derivatives.

Generally, the first type of monomer comprises about 5% to about 50%, preferably about 7% to about 25% , and more preferably about 10% to about 20% by weight, of the total monomer solution (prior to polymerization).

Further, a second type of monomer or group of monomers is provided, generally as a crosslinking agent, during the polymerization. Such a monomer has more than one ethylenically unsaturated acids and acid derivatives functional groups. It is generally of the formula (but not limited to): 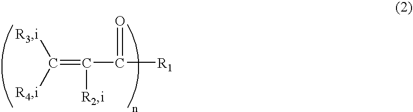
wherein i=1→n, and n≧2;
R2,i, R3,i, and R4,i may be independently selected from, but are not limited to, the group consisting of H, C, C2-C6 alkanes, C2-C6 alkenes, C2-C6 alkynes, aromatics, halogens, carboxylic acid derivatives, sulfates and nitrates;
R1 may be selected from, but is not limited to, the group consisting of N, NR5, NH, O, and carboxylic-acid derivatives, wherein R5 may be selected from the group consisting of H, C, C2-C6 alkanes, C2-C6 alkenes, C2-C6 alkynes, and aromatics.

Suitable monomers for use generally as crosslinking agents of the above general formula (2) include methylenebisacrylamide, ethylenebisacrylamide, any water-soluble N,N′-alkylidene-bis(ethylenically unsaturated amide)

Another suitable crosslinking agent may be represented by the formula: 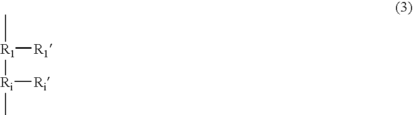
wherein i=1→n, and n≧2;
wherein R₁ and Rᵢ may be the same or different, and selected from the group consisting of, but not limited to, N, NR5, NH, O, and carboxylic-acid derivatives, wherein R5 may be selected from the group consisting of H, C, C2-C6 alkanes, C2-C6 alkenes, C2-C6 alkynes, and aromatics; and
wherein R₁′ and Rᵢ′ may be the same or different, and selected from the group consisting of, but not limited to, acrylics and acrylic derivatives, and alkenes.

Another embodiment of a crosslinking agent has the following general formula:, 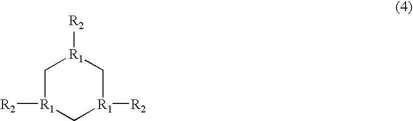
wherein the R₁ groups may be the same or different, and selected from the group consisting of, but not limited to, N, NR5, NH, O, and carboxylic-acid derivatives, wherein R5 may be selected from the group consisting of H, C, C2-C6 alkanes, C2-C6 alkenes, C2-C6 alkynes, and aromatics; and
wherein the R₂ groups may be the same or different, and selected from the group consisting of, but not limited to, acrylics and acrylic derivatives, and alkenes.

One particularly suitable compound of the formula (4) is 1,3,5-Triacryloylhexahydro-1,3,5-triazine.

Such crosslinking monomers (e.g., of the general formulas (2), (3) or (4) generally comprise about 0.01% to about 15%, preferably about 0.5% to about 5% , and more preferably about 1% to about 3% by weight, of the total monomer solution (prior to polymerization).

The water soluble or water swellable polymer, which acts as a reinforcing element, may comprise poly vinyl alcohol (PVA), polysulfone (anionic), poly(sodium-4-styrenesulfonate), carboxymethyl cellulose, sodium salt of poly(styrenesulfonic acid-co-maleic acid), corn starch, any other water-soluble or water-swellable polymers, or combinations comprising at least one of the foregoing polymers. The addition of the reinforcing element enhances the ionic conductivity and mechanical strength of the separator. Such water soluble or water swellable polymers generally comprise about 0% to about 30%, preferably about 1% to about 10%, and more preferably about 1% to about 4% by weight, of the total monomer solution (prior to polymerization).

A polymerization initiator may also be included, such as ammonium persulfate, alkali metal persulfates and peroxides, other initiators, or combinations comprising at least one of the foregoing initiators. Such initiators may generally comprise about 0% to about 3% of the solution prior to polymerization. Further, an initiator may be used in combination with radical generating methods such as radiation, including for example, ultraviolet light, X-ray, γ-ray, and the like. However, the chemical initiators need not be added if the radiation alone is sufficiently powerful to begin the polymerization. Specific examples of suitable polymerization initiators include, but are not limited to, 1-phenyl-2-methyl-2-hydroxypropanone, 2-hydroxy-2-methylpropiophenone, ammonium persulfate, 4,4′-diazidostilbene-2,2′-disulfonic acid disodium salt, benzenediazonium 4-(phenylamino)-sulfate (1:1) polymer with formaldehyde, 2-(2-(vinyloxy)ethoxy)-ethanol. These initiators may be combined with charge-transfer compounds, such as triethanolamine, to enhance activity.

Polymerization is generally carried out at a temperature ranging from room temperature to about 130° C. In certain embodiments, polymerization is heat induced, wherein an elevated temperature, ranging from about 75° to about 100° C., is preferred. Optionally, the polymerization may be carried out using radiation in conjunction with heating. Alternatively, the polymerization may be performed using radiation alone without raising the temperature of the ingredients, depending on the strength of the radiation. Examples of radiation types useful in the polymerization reaction include, but are not limited to, ultraviolet light, gamma rays, x-rays, electron beam, or a combination thereof.

In certain embodiments, water or some liquid electrolyte may be used as the solvent added to the monomer solution. The solvent serves to accommodate the matrix structure, thus acting as a space holder to define the volume of the cured polymer. The amount of solvent used in the reaction process and the degree of cross-linking of the polymer are decided to such that the formed membrane has a minimal or desired volume change when soaked in the electrolyte of the electrochemical device. Generally, the solvent comprises about 50% to about 90%, on a weight basis, preferably about 60% to about 80%, and more preferably about 62% to about 75% of the polymer matrix material.

To form an ionic membrane, the water can be replaced with a solution of the proper concentration of the desired ionic species. Since the volume of the polymer matrix membrane has been carefully decided by using appropriate amount of water, water can be replaced with a solution of the proper concentration of the desired ionic species with minimal or desirable swelling or shrinking, depending on the application. This is important because the capability of blocking dendrite penetration and the ionic conductivity are critically linked to the volume, cross-linking degree, and tortuosity of the membrane. Excess swelling of a polymer can reduce the dendrite-blocking capability of the final material. If, however, the material does not provide sufficient electrolyte volume, conductivity is reduced. Generally, the volume of the polymer matrix material after species replacement deviates from the volume of the polymer matrix material before species replacement by less than about 50%, preferably less than about 20%, and more preferably less than about 5%. The solution-replacement treatment may be in the form of dipping, soaking, spraying, contacting with ion-exchange resins, or other techniques known to those skilled in the art.

In one method of forming the polymeric material the monomer solution, and an optional polymerization initiator is polymerized by heating, irradiating with ultraviolet light, gamma-rays, x-rays, electron beam, or a combination thereof, wherein a polymer matrix material is produced. When the ionic species is included in the polymerized solution, the ions remains in solution after the polymerization. Further, to change or add a desired solution to the polymer matrix, the desired solution may be added to the polymer matrix, for example, by soaking the polymer matrix therein.

A polymer matrix membrane formed of the polymer matrix material may comprise, in part, a support material or substrate, which is preferably a woven or nonwoven fabric, such as a polyolefin, polyvinyl alcohol, cellulose, or a polyamide, such as nylon. Alternatively, the substrate/support may be the negative electrode, charging electrode, or positive electrode (not illustrated).

In another method of forming a polymer matrix membrane, the selected fabric may be soaked in the monomer solution (with or without the desired solution species), the solution-coated fabric is cooled, and a polymerization initiator is optionally added. The monomer solution may be polymerized by heating, irradiating with ultraviolet light, gamma-rays, x-rays, electron beam, or a combination thereof, wherein the polymeric material is produced.

When the desired species is included in the polymerized solution, the species remains in solution after the polymerization. Further, when the polymeric material does not include the ionic species (or contains a partial amount of the desired ionic species), the solvent can be replaced with a solution of the proper concentration of the desired ionic species (the “solution-replacement treatment”). The solution-replacement treatment may be in the form of dipping, soaking, spraying, contacting (in the presence of a liquid) with ion-exchange resins, or other techniques known to those skilled in the art. The solution-replacement treatment may occur as a separate step prior to inclusion of the membrane in a nickel-zinc cell, or alternatively the membrane may be included in the cell no including the ionic species (or containing a partial amount of the desired ionic species) and the solution-replacement treatment may occur with inclusion of liquid electrolyte (as described generally with reference to FIG. 3).

The hydroxide ionic species for the nickel-zinc cell may come from an aqueous alkaline solution of potassium hydroxide, sodium hydroxide, lithium hydroxide, or combinations thereof. Preferably, in a potassium hydroxide solution, for example, the base has a concentration ranging from about 0.1 wt. % to about 55 wt. %, and most preferably about 30 wt. % to about 45 wt. %. To control the thickness of the membrane, the monomer solution or monomer solution applied to a fabric may be placed in suitable molds prior to polymerization. Alternatively, the fabric coated with the monomer solution may be placed between suitable films such as glass, polypropylene, and polyethylene teraphthalate (PET) film. The thickness of the film may be varied, and will be obvious to those of skill in the art based on its effectiveness in a particular application. In certain embodiments, the membrane or separator may have a thickness of about 0.1 mm to about 0.6 mm. Because the actual conducting media remains in aqueous solution within the polymer backbone, the conductivity of the membrane is comparable to that of liquid electrolytes, which at room temperature is significantly high.

The polymer matrix material may be in the form of a hydrogel material with high conductivities, particularly at room temperature. The material possesses a definite macrostructure (i.e., form or shape). Further, the material does not recombine, for example, if a portion of the polymer matrix material is cut or otherwise removed, physically recombining them is typically not accomplished by mere contact between the portions, and the portions remain distinct. This is in contrast to gelatinous materials (e.g., Carbopol® based materials), which are typically fluid and have no independent macrostructure, and recombination of several separated portions results in an indistinguishable mass of material.

Since the electrolyte remains in solution phase within the polymer matrix, high conductivities can be expected. The polymer matrix membrane also prevents penetration of dendrite metal through the membrane and therefore protects the negative electrode from dendrite formation, particularly during charging. Furthermore, the polymer matrix membrane also prevents destruction of the cell by preventing diffusion of the metal oxidation product into the electrolyte solution. Also, conventional methods of reducing ionic concentration to minimize detriments of dentrites can be avoided, as the membrane serves the dendrite protection purpose.

The zinc electrode may be any conventionally known zinc electrode, for example as used in conventional nickel-zinc cells or zinc air cells, and generally comprises a metal constituent such as metal and/or metal oxides and a current collector. Optionally an ionic conducting medium is provided within each zinc electrode. Further, in certain embodiments, the zinc electrode comprises a binder and/or suitable additives. Preferably, the formulation optimizeshigh rate capability, capacity, density, and high depth of discharge performance, while minimizing shape change during cycling.

The metal constituent may comprise mainly zinc and zinc oxide, which may also be mixed or alloyed with constituents including, but not limited to, bismuth, calcium, magnesium, aluminum, indium, lead, mercury, carbon, gallium, tin, cadmium, germanium, antimony, selenium, thallium, oxides of at least one of the foregoing metals, or combinations comprising at least one of the foregoing constituents. The zinc may be provided in the form of powder, fibers, dust, granules, flakes, needles, pellets, or other particles.

The zinc electrode current collector may be any electrically conductive material capable of providing electrical conductivity. The current collector may be formed of various electrically conductive materials chemically compatible with nickel-zinc systems including, but not limited to, copper, brass, silver, carbon, ferrous metals such as stainless steel, nickel, or other electrically conducting materials that are stable in alkaline environments and do not corrode the electrode, or combinations and alloys comprising at least one of the foregoing materials. The current collector may be in the form of a mesh, perforated plate, metal foam, strip, wire, plate, or other suitable structure.

The optional binder of the zinc electrode primarily maintains the constituents of the electrode in a solid or substantially solid form in certain configurations. The binder may be any material that generally adheres the zinc electrode material and the current collector to form a suitable structure, and is generally provided in an amount suitable for adhesive purposes of the zinc electrode. This material is preferably chemically stable to the electrochemical environment. In certain embodiments, the binder material is soluble, or can form an emulsion, in water, and is not soluble in an electrolyte solution. Appropriate binder materials include polymers and copolymers based on polytetrafluoroethylene (e.g., Teflon® and Teflon® T-30 commercially available from E.I. du Pont Nemours and Company Corp., Wilmington, Del.), polyvinyl alcohol (PVA), polystyrenesulfonic acid and its salts, carboxymethyl cellulose, poly(ethylene oxide) (PEO), polyvinylpyrrolidone (PVP), and the like, and derivatives, combinations and mixtures comprising at least one of the foregoing binder materials. However, one of skill in the art will recognize that other binder materials may be used.

An additional electrolyte or ionic conducting medium may also be provided in the battery (FIG. 3), generally comprising alkaline media to provide a path for hydroxyl to reach the electrodes. The ionically conducting medium may be in the form of a bath, wherein a liquid electrolyte solution is suitably contained. As described above, this bath may serve as the source of ionic species for solution replacement treatments. In certain embodiments, an ion conducting electrolyte is provided in the zinc electrode. The electrolyte generally comprises ionic conducting materials such as KOH, NaOH, LiOH, other materials, or a combination comprising at least one of the foregoing electrolyte media. It may also contain gelatinous materials (e.g., Carbopol® based materials) to increase the viscosity of the electrolyte. Particularly, the electrolyte may comprise aqueous electrolytes having a concentration of about 2.5% ionic conducting materials to about 55% ionic conducting materials, preferably about 10% ionic conducting materials to about 50% ionic conducting materials, and more preferably about 30% ionic conducting materials to about 45% ionic conducting materials. Other electrolytes may instead be used, however, depending on the capabilities thereof, as will be obvious to those of skill in the art.

To provide a cell that minimizes or obviates the need for a liquid electrolyte material, the zinc electrode may include an ionic conductive electrolyte gel incorporated and cured therein. This may be accomplished during original shaping of the zinc electrode (e.g., or at a later stage of processing).

The positive nickel based electrode may be any known positive electrode used in nickel-zinc, nickel cadmium, or nickel metal hydride batteries. For example, in a sintered design, a perforated or wire mesh nickel or nickel-plated steel substrate of is sintered with a carbonyl nickel powder layer or layers to form a porous electrode plaque. The resultant porous plaque is conventionally impregnated with a solution of an electrochemically active material precursor, typically nickel nitrate. The electrochemically active nickel hydroxide material is precipitated out of solution within the plate.

In addition, a high porosity nickel positive electrode can be utilized in which an electrochemically active nickel material may be incorporated in a porous substrate such as a highly porous metal foam or fibrous mat. For example, a slurry or paste containing the active material may be pressed on to and within interstices of the porous metal foam or fibrous mat substrate, and subsequently compacted to a desired thickness to form a positive nickel electrode.

While preferred embodiments have been shown and described, various modifications and substitutions may be made thereto without departing from the spirit and scope of the invention. Accordingly, it is to be understood that the present invention has been described by way of illustrations and not limitation.

1. A nickel-zinc battery comprising a zinc based electrode, a nickel based electrode, and polymer matrix membrane having a crosslinked structure, the polymer matrix membrane comprising
a polymerization product of one or more monomers selected from the group of water-soluble, ethylenically-unsaturated acids and acid derivatives; and
a crosslinking agent,
wherein aqueous electrolyte is supported within a volume within the polymer matrix membrane created by the crosslinked structure.

2. The nickel-zinc battery as in claim 1, wherein the polymer matrix membrane further comprises a water-soluble or water-swellable polymer.

3. The nickel-zinc battery as in claim 1, wherein the polymer matrix membrane further comprises a chemical polymerization initiator.

4. The nickel-zinc battery as in claim 1, wherein the polymer matrix membrane further comprises a water-soluble or water-swellable polymer; and a chemical polymerization initiator.

5. The nickel-zinc battery as in claim 1, wherein the water soluble ethylenically unsaturated acids and acid derivatives of the polymer matrix membrane have the general formula: 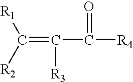
wherein R1, R2, and R3 are independently selected from the group consisting of H, C, C2-C6 alkanes, C2-C6 alkenes, C2-C6 alkynes, aromatics, halogens, carboxylic acid derivatives, sulfates and nitrates; and
R4 is selected from the group consisting of NR5, NHR5, NH2, OH, H, halides, OR5, and carboxylic acid derivatives, wherein R5 is selected from the group consisting of H, C, C2-C6 alkanes, C2-C6 alkenes, C2-C6 alkynes, and aromatics.

6. The nickel-zinc battery as in claim 1, wherein the water soluble ethylenically unsaturated acids and acid derivatives of the polymer matrix membrane are selected from the group consisting of methylenebisacrylamide, acrylamide, methacrylic acid, acrylic acid, fumaramide, fumaric acid, N-isopropylacrylamide, N, N-dimethylacrylamide, 3,3-dimethylacrylic acid, maleic anhydride, and combinations comprising at least one of the foregoing ethylenically unsaturated acids and derivatives.

7. The nickel-zinc battery as in claim 1, wherein the water soluble ethylenically unsaturated acids and acid derivatives of the polymer matrix membrane are selected from the group consisting of 1-vinyl-2-pyrrolidinone, the sodium salt of vinylsulfonic acid, and combinations comprising at least one of the foregoing ethylenically unsaturated acids and derivatives.

8. The nickel-zinc battery as in claim 1, wherein the ethylenically unsaturated acids or acid derivatives of the polymer matrix membrane comprises about 5% to about 50%, by weight, of the total monomer solution prior to polymerization.

9. The nickel-zinc battery as in claim 1, wherein the ethylenically unsaturated acids or acid derivatives of the polymer matrix membrane comprises about 7% to about 25%, by weight, of the total monomer solution prior to polymerization.

10. The nickel-zinc battery as in claim 1, wherein the ethylenically unsaturated acids or acid derivatives of the polymer matrix membrane comprises about 10% to about 20%, by weight, of the total monomer solution prior to polymerization.

11. The nickel-zinc battery as in claim 1, wherein the crosslinking agent of the polymer matrix membrane is of the general formula: 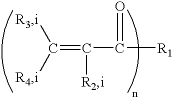
wherein i=1→n, and n≧2;
R2,i, R3,i, and R4,i are independently selected from the group consisting of H, C, C2-C6 alkanes, C2-C6 alkenes, C2-C6 alkynes, aromatics, halogens, carboxylic acid derivatives, sulfates and nitrates;
R1 is selected from the group consisting of N, NR5, NH, O, and carboxylic-acid derivatives, wherein R5 is selected from the group consisting of H, C, C2-C6 alkanes, C2-C6 alkenes, C2-C6 alkynes, and aromatics.

12. The nickel-zinc battery as in claim 1, wherein the crosslinking agent of the polymer matrix membrane is selected from the group consisting of methylenebisacrylamide, ethylenebisacrylamide, any water-soluble N,N′-alkylidene-bis(ethylenically unsaturated amide), 1,3,5-Triacryloylhexahydro-1,3,5-triazine, and combinations comprising at least one of the foregoing crosslinking agents.

13. The nickel-zinc battery as in claim 1, wherein the crosslinking agent of the polymer matrix membrane comprises about 0.01% to about 15%, by weight, of the total monomer solution prior to polymerization.

14. The nickel-zinc battery as in claim 1, wherein the crosslinking agent of the polymer matrix membrane comprises about 0.5% to about 5%, by weight, of the total monomer solution prior to polymerization.

15. The nickel-zinc battery as in claim 1, wherein the crosslinking agent of the polymer matrix membrane comprises about 1% to about 3%, by weight, of the total monomer solution prior to polymerization.

16. The polymer matrix material as in claim 1, wherein the electrolyte comprises KOH.

17. The nickel-zinc battery as in claim 2, wherein the water-soluble or water-swellable polymer of the polymer matrix membrane is selected from the group consisting of polysulfone (anionic), poly(sodium-4-styrenesulfonate), carboxymethyl cellulose, polysulfone (anionic), sodium salt of poly(styrenesulfonic acid-co-maleic acid), corn starch, any other water-soluble or water-swellable polymers, and combinations comprising at least one of the foregoing polymers.

18. The nickel-zinc battery as in claim 2, wherein the water-soluble or water-swellable polymer of the polymer matrix membrane comprises less than about 30%, by weight, of the polymer matrix material.

19. The nickel-zinc battery as in claim 2, wherein the water-soluble or water-swellable polymer of the polymer matrix membrane comprises about 1% to about 10%, by weight, of the polymer matrix material.

20. The nickel-zinc battery as in claim 2, wherein the water-soluble or water-swellable polymer of the polymer matrix membrane comprises about 1% to about 4%, by weight, of the polymer matrix material.

21. The nickel-zinc battery as in claim 4, wherein the water-soluble or water-swellable polymer of the polymer matrix membrane is selected from the group consisting of polysulfone (anionic), poly(sodium-4-styrenesulfonate), carboxymethyl cellulose, polysulfone (anionic), sodium salt of poly(styrenesulfonic acid-co-maleic acid), corn starch, any other water-soluble or water-swellable polymers, and combinations comprising at least one of the foregoing polymers.

22. The nickel-zinc battery as in claim 4, wherein the water-soluble or water-swellable polymer of the polymer matrix membrane comprises less than about 30%, by weight, of the polymer matrix material.

23. The nickel-zinc battery as in claim 4, wherein the water-soluble or water-swellable polymer of the polymer matrix membrane comprises about 1% to about 10%, by weight, of the polymer matrix material.

24. The nickel-zinc battery as in claim 4, wherein the water-soluble or water-swellable polymer of the polymer matrix membrane comprises about 1% to about 4%, by weight, of the polymer matrix material.

25. The nickel-zinc battery as in claim 3, wherein the chemical polymerization initiator is selected from the group consisting of ammonium persulfate, alkali metal persulfates and peroxides, and combinations comprising at least one of the foregoing initiators.

26. The nickel-zinc battery as in claim 3, wherein the chemical polymerization initiator comprises less than about 3%, by weight, of the polymer matrix material.

27. The nickel-zinc battery as in claim 4, wherein the chemical polymerization initiator is selected from the group consisting of ammonium persulfate, alkali metal persulfates and peroxides, and combinations comprising at least one of the foregoing initiators.

28. The nickel-zinc battery as in claim 4, wherein the chemical polymerization initiator comprises less than about 3%, by weight, of the polymer matrix material.
